(19) United States
(12) Patent Application Publication
(10) Pub. No.: US 2018/0039452 A1
(43) Pub. Date: Feb. 8, 2018

(54) IMAGE FORMING APPARATUS, USAGE RECORD INFORMATION OUTPUT METHOD, AND INFORMATION PROCESSING SYSTEM

(71) Applicant: Akira NAGAMORI, Kanagawa (JP)

(72) Inventor: Akira NAGAMORI, Kanagawa (JP)

(73) Assignee: Ricoh Company, Ltd., Tokyo (JP)

(21) Appl. No.: 15/647,573

(22) Filed: Jul. 12, 2017

(30) Foreign Application Priority Data
Aug. 3, 2016 (JP) 2016-153007

(51) Int. Cl. G06F 3/12; H04N 1/21; H04N 1/00

(52) U.S. Cl. CPC G06F 3/1203; G06F 3/1253; H04N 1/00832; H04N 1/21; H04N 2201/0094

(57) ABSTRACT

An image forming apparatus acquires and displays device-usage record information, which is related to a usage record of at least one device. The image forming apparatus includes a processor, in communication with a memory, executing a process including acquiring uniqueness information of the image forming apparatus from a usage record information storage device via a network in response to accepting a user operation input via a user interface, the usage record information storage device being configured to receive data from the at least one device, generate the device-usage record information based on the received data, and to store the device-usage record information in association with the uniqueness information of the at least one device; acquiring, from the usage record information storage device, the device-usage record information stored in association with the acquired uniqueness information of the image forming apparatus; and outputting the acquired device-usage record information.

### CROSS-REFERENCE TO RELATED APPLICATION

The present application claims priority under 35 U.S.C. §119 to Japanese Patent Application No. 2016-153007, filed on Aug. 3, 2016, the contents of which are incorporated herein by reference in their entirety.

### BACKGROUND OF THE INVENTION

### 1. Field of the Invention

The present invention relates to an image forming apparatus, a usage record information output method, and an information processing system.

### 2. Description of the Related Art

There is a known technology of recording the usage amount of, for example, an image forming apparatus in the image forming apparatus, and printing out printed matter according to the usage amount.

In the related art, there is a system for storing and providing print accounting information. This system records at least one of a plurality of events in a printing device; updates the stored print accounting information at every period induced by an event, based on the recorded plurality of events; and creates a report of each period including print accounting information that can be read by a person and print accounting information that is encoded (see, for example, Patent Document 1).

Patent Document 1: Japanese Unexamined Patent Application Publication No. 2008-102922

### SUMMARY OF THE INVENTION

An aspect of the present invention provides an image forming apparatus, a usage record information output method, and an information processing system, in which one or more of the disadvantages of the related art are reduced.

According to one aspect of the present invention, there is provided an image forming apparatus for acquiring and displaying device-usage record information, which is related to a usage record of at least one device, the at least one device including the image forming apparatus, the image forming apparatus including a processor, in communication with a memory, executing a process including acquiring uniqueness information of the image forming apparatus from a usage record information storage device via a network in response to accepting a user operation input via a user interface, the usage record information storage device being configured to receive data from the at least one device, generate the device-usage record information based on the received data, and to store the device-usage record information in association with the uniqueness information of the at least one device; acquiring, from the usage record information storage device, the device-usage record information stored in association with the acquired uniqueness information of the image forming apparatus; and outputting the acquired device-usage record information.

### BRIEF DESCRIPTION OF THE DRAWINGS

FIG. 1 illustrates an example of an information processing system according to a first embodiment of the present invention;

FIG. 2 is an example of a hardware block diagram of a computer according to the first embodiment of the present invention;

FIG. 3 is an example of a hardware block diagram of a multifunction peripheral according to the first embodiment of the present invention;

FIG. 4 is an example of a process block diagram of a counter accumulation device according to the first embodiment of the present invention;

FIG. 5 is an example of a process block diagram of the multifunction peripheral according to the first embodiment of the present invention;

FIG. 6 is a configuration diagram of an example of counter settings according to the first embodiment of the present invention;

FIG. 7 is a configuration diagram of an example of daily data according to the first embodiment of the present invention;

FIG. 8 is a configuration diagram of an example of monthly data according to the first embodiment of the present invention;

FIG. 9 is a configuration diagram of an example of customer information according to the first embodiment of the present invention;

FIG. 10 is a configuration diagram of an example of device information according to the first embodiment of the present invention;

FIG. 11 is a flowchart of an example of a counter accumulation process according to the first embodiment of the present invention;

FIG. 12 is a sequence diagram of an example of a display process and a print process of a report according to the first embodiment of the present invention;

FIG. 13 is an image diagram of an example of a usable application list screen according to the first embodiment of the present invention;

FIG. 14 is an image diagram of an example of a report displayed on an operation panel according to the first embodiment of the present invention;

FIG. 15 is a sequence diagram of an example of a display process and a mail sending process of a report according to anther embodiment of the present invention; and

FIG. 16 is a configuration of an example of the information processing system according to anther embodiment of the present invention.

### DETAILED DESCRIPTION OF THE PREFERRED EMBODIMENTS

In the image forming apparatus of the related art that records the usage amount within the apparatus, in order to record the usage amount of a long period of time, there is a need to prepare a storage, such as a hard disk drive (HDD), etc., that can record large volumes of data. Furthermore, in the image forming apparatus of the related art, which records the usage amount within the apparatus, when multiple types of usage amounts need to be stored, there is a need to prepare a storage having an even larger capacity.

A problem to be solved by an embodiment of the present invention is to provide an image forming apparatus that can easily output information relevant to the usage record of the image forming apparatus, without increasing the recording capacity of the image forming apparatus.

Embodiments of the present invention will be described by referring to the accompanying drawings.

### First Embodiment

### <System Configuration>

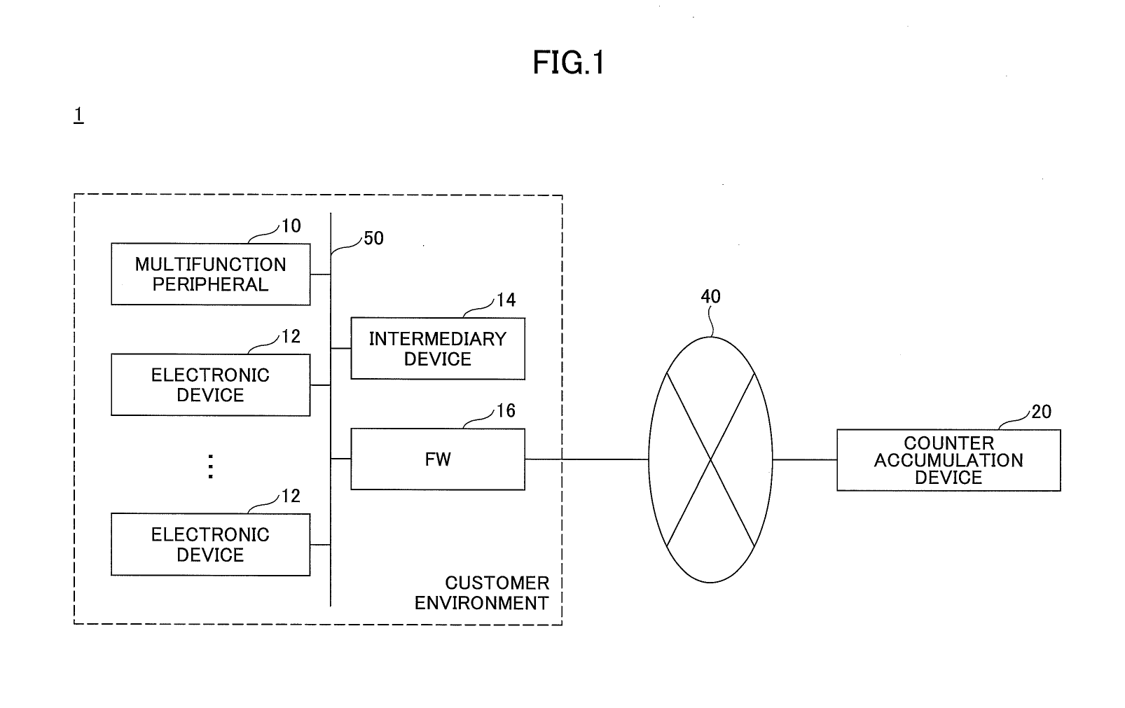

FIG. 1 illustrates an example of an information processing system according to a first embodiment. In an information processing system 1 of FIG. 1, a customer environment is coupled to a counter accumulation device 20 via a network 40 such as the Internet.

The customer environment is a network environment on the customer side. Note that a customer may be an organization such as a company, a group, and a department, or an individual user. The customer environment includes a multifunction peripheral 10, one or more electronic devices 12, an intermediary device 14, and a firewall 16, which are coupled to each other via a network 50 such as a Local Area Network (LAN), etc.

The multifunction peripheral 10 is an example of an image forming apparatus. The multifunction peripheral 10 is a multifunction printer including, for example, a print function, a scan function, a copy function, and a fax function. Furthermore, the electronic device 12 is also an example of an image forming apparatus. The electronic device 12 is, for example, a laser printer, a projector, an electronic whiteboard, a videoconferencing device, a camera, an industrial device or a medical device including a communication function, etc.

Furthermore, the intermediary device 14 collects, from the multifunction peripheral 10 and the electronic device 12, information (counter value) indicating the usage record of the multifunction peripheral 10 and the electronic device 12, and collectively sends the counter values to the counter accumulation device 20. Note that the multifunction peripheral 10 may send the counter values to the counter accumulation device 20 without involving the intermediary device 14. There are cases where the information processing system 1 does not include the intermediary device 14. Note that the counter value sent to the counter accumulation device 20 is also referred to as a lifetime counter value, which is a value that is continuously counted every time a corresponding function is used, from when the multifunction peripheral 10 or the electronic device 12 is manufactured to the present time point.

The counter accumulation device 20 accumulates the counter values of the multifunction peripheral 10 and the electronic device 12 received from the customer environment, as described below. Furthermore, the counter accumulation device 20 acquires uniqueness information of the device (the multifunction peripheral 10 or the electronic device 12) from the multifunction peripheral 10, and provides a counter value corresponding to the uniqueness information to the multifunction peripheral 10. The multifunction peripheral 10, which has received the counter value, displays a report of the usage amount of the multifunction peripheral 10 or the electronic device 12 as follows, based on the counter value provided from the counter accumulation device 20.

Note that the information processing system 1 of FIG. 1 is one example; there may be one or more intervening server devices (a proxy server or a gateway server, etc.) between the customer environment and the counter accumulation device 20. The counter accumulation device 20 may be implemented by being distributed over a plurality of information processing apparatuses. Furthermore, part of or all of the functions of the counter accumulation device 20 may be included in another server device.

As described above, in the information processing system 1 according to the present embodiment, information indicating the usage record of the multifunction peripheral 10 and the electronic device 12 is collected in the counter accumulation device 20. The multifunction peripheral 10 specifies the uniqueness information of the device (device-uniqueness information) to acquire the counter value from the counter accumulation device 20. The multifunction peripheral 10 can display a report of the usage amount of the multifunction peripheral 10 or the electronic device 12 as described below, based on the acquired counter value.

### <Hardware Configuration>

<<Computer>>

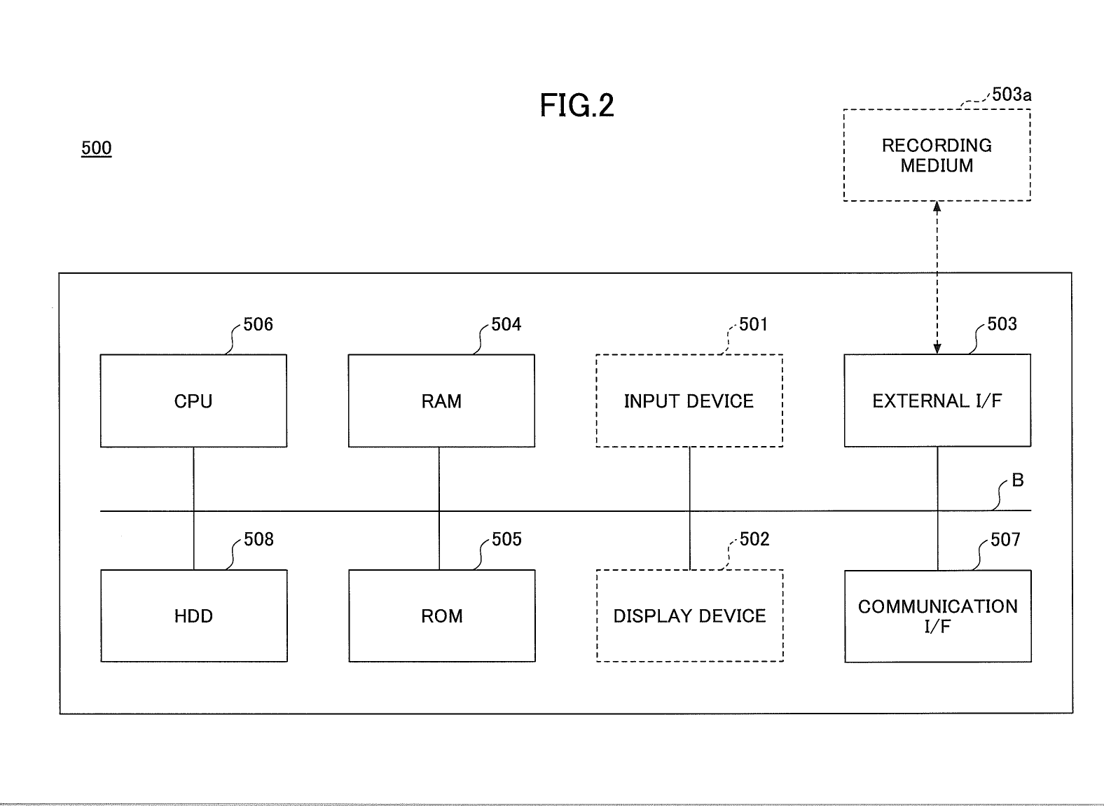

One or more information processing apparatuses implementing the counter accumulation device 20 of FIG. 1 is implemented by a computer having a hardware configuration, for example, as illustrated in FIG. 2.

FIG. 2 is an example of a hardware block diagram of a computer. A computer 500 illustrated in FIG. 2 includes an input device 501, a display device 502, an external interface (I/F) 503, a Random Access Memory (RAM) 504, a Read-Only Memory (ROM) 505, a Central Processing Unit (CPU) 506, a communication I/F 507, and a Hard Disk Drive (HDD) 508, which are coupled to each other by a bus B. Note that the input device 501 and the display device 502 may have a configuration of being coupled and used when necessary.

The input device 501 includes a keyboard, a mouse, and a touch panel, etc., and is used by the user for inputting various operation signals. The display device 502 includes a display, etc., and displays processing results obtained by the computer 100.

The communication I/F 507 is an interface that connects the computer 500 to various networks. Accordingly, the computer 500 is able to perform data communication via the communication I/F 507.

The HDD 508 is a non-volatile storage device for storing programs and data. Examples of the stored programs and data include an OS that is the basic software for controlling the entire computer 500, and application software (hereinafter, simply referred to as an “application”) for providing various functions in the OS. Note that the computer 500 may use a drive device (for example, a solid state drive (SSD)) using a flash memory as the storage medium, instead of the HDD 508.

The external I/F 503 is an interface between the computer 500 and an external device. An example of the external device is a recording medium 503a. Accordingly, the computer 500 is able to read and/or write in the recording medium 503a via the external I/F 503. Examples of the recording medium 503a are a flexible disk, a Compact Disc (CD), a Digital Versatile Disc (DVD), a Secure Digital (SD) memory card, and a Universal Serial Bus (USB) memory.

The ROM 505 is a non-volatile semiconductor memory (storage device) that can store programs and data even after the power is turned off. The ROM 505 stores programs and data such as a Basic Input/Output System (BIOS) that is executed when the computer 500 is activated, OS settings, and network settings, etc. The RAM 504 is a volatile semiconductor memory (storage device) for temporarily storing programs and data.

The CPU 506 is an arithmetic device for controlling the entire computer 500 and implementing functions of the computer 500, by loading the programs and data from the storage devices such as the ROM 505 and the HDD 508, into the RAM 104, and executing processes. The counter accumulation device 20 is able to implement various processes described below, by the hardware configuration of the computer 500, for example, as illustrated in FIG. 2.

### <<Multifunction Peripheral>>

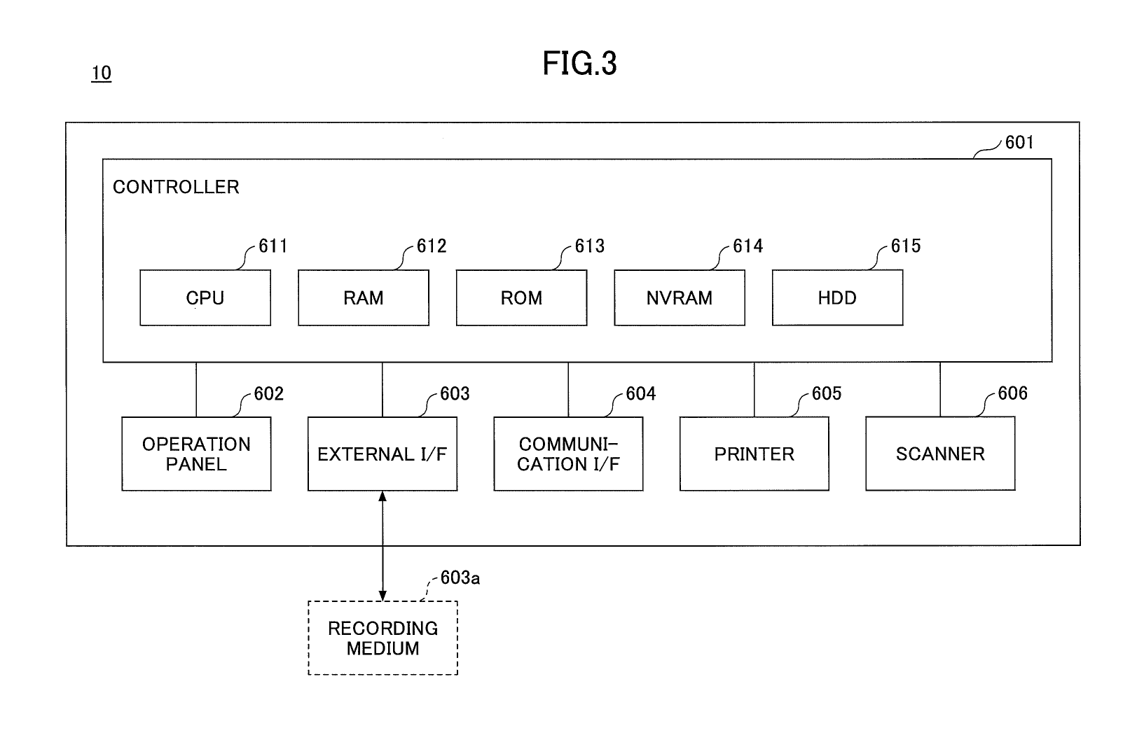

The multifunction peripheral 10 of FIG. 1 is implemented by a computer having a hardware configuration, for example, as illustrated in FIG. 3. FIG. 3 is an example of a hardware block diagram of the multifunction peripheral 10. The multifunction peripheral 10 illustrated in FIG. 3 includes a controller 601, an operation panel 602, an external I/F 603, a communication I/F 604, a printer 605, and a scanner 606.

The controller 601 includes a CPU 611, a RAM 612, a ROM 613, a NVRAM 614, and a HDD 615. The ROM 613 stores various programs and data. The RAM 612 temporarily stores programs and data. The NVRAM 614 stores, for example, setting information. Furthermore, the HDD 615 stores various programs and data.

The CPU 611 controls the entire multifunction peripheral 10 and implements functions of the multifunction peripheral 10, by loading the programs, the data, and setting information from the ROM 613, the NVRAM 614, and the HDD 615, into the RAM 612, and executing processes.

The operation panel 602 includes an input unit for accepting input from a user, and a display unit for displaying information. The external I/F 603 is an interface between the multifunction peripheral 10 and an external device. An example of the external device is a recording medium 603a. Accordingly, the multifunction peripheral 10 is able to read and/or write in the recording medium 603a via the external I/F 603. Examples of the recording medium 603a are an integrated circuit (IC) card, a flexible disk, a CD, a DVD, an SD memory card, and a USB memory.

Furthermore, the communication I/F 604 is an interface that couples the multifunction peripheral 10 to the network 50. Accordingly, the multifunction peripheral 10 is able to perform data communication via the communication I/F 604. The printer 605 is a printing device for printing print data onto a conveyed object. Examples of a conveyed object are paper, a coat sheet, cardboard, an Over Head Projector (OHP) film, a plastic film, prepreg, and copper foil, etc., and the conveyed object is not limited to paper. Furthermore, the scanner 606 is a reading device for reading image data (electronic data) from an original document. Note that descriptions of the hardware configuration of the electronic device 12 of FIG. 1 is omitted.

### <Software Configuration>

<<Counter Accumulation Device>>

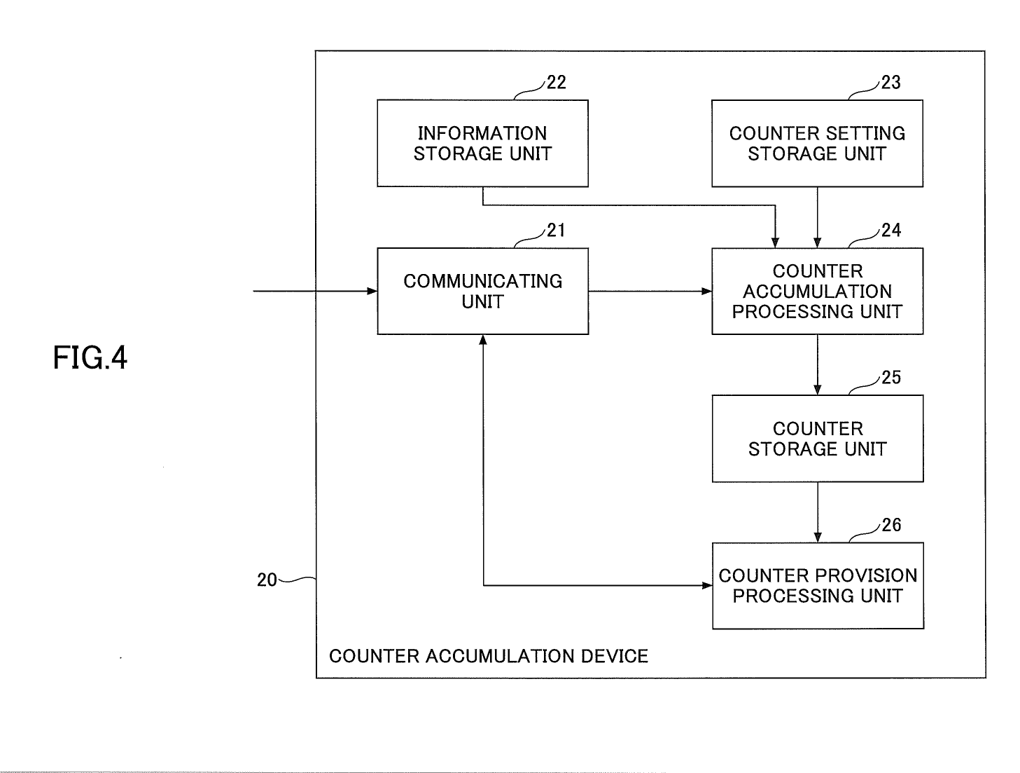

The counter accumulation device 20 according to the present embodiment is implemented by, for example, the process blocks illustrated in FIG. 4. FIG. 4 is an example of a process block diagram of the counter accumulation device 20 according to the present embodiment. The counter accumulation device 20 executes programs to implement the process blocks as illustrated in FIG. 4.

The counter accumulation device 20 illustrated in FIG. 4 implements a communicating unit 21, an information storage unit 22, a counter setting storage unit 23, a counter accumulation processing unit 24, a counter storage unit 25, and a counter provision processing unit 26. The communicating unit 21 performs data communication with external devices. For example, the communicating unit 21 performs data communication with the multifunction peripheral 10 and the intermediary device 14.

The information storage unit 22 stores customer information and device information described below. According to the customer information and device information, it is possible to identify the multifunction peripheral 10 or the electronic device 12 that is installed in the customer environment, and to identify the daily data and the monthly data of the identified multifunction peripheral 10 or electronic device 12. The counter setting storage unit 23 stores counter settings described below. The counter settings are information necessary for accumulating the counter values at the counter accumulation processing unit 24. The counter accumulation processing unit 24 stores the daily data and the monthly data of each of the multifunction peripheral 10 and the electronic device 12 in the counter storage unit 25, based on the counter setting. Note that the counter accumulation processing unit 24 may further store the daily data and the monthly data of each customer environment, in the counter storage unit 25.

The counter storage unit 25 stores the daily data and the monthly data of each of the multifunction peripheral 10 and the electronic device 12. The counter storage unit 25 may store the daily data and the monthly data of each customer environment.

The counter provision processing unit 26 provides the daily data and the monthly data of the multifunction peripheral 10 or the electronic device 12 stored in the counter storage unit 25, in response to a request specifying the uniqueness information of the multifunction peripheral 10 or the electronic device 12. Furthermore, the counter provision processing unit 26 may provide, to the multifunction peripheral 10, the daily data and the monthly data of each customer environment stored in the counter storage unit 25, in response to a request specifying the uniqueness information of a customer from the multifunction peripheral 10. Furthermore, the counter provision processing unit 26 may provide, to the multifunction peripheral 10, the daily data and the monthly data of a customer environment associated with the uniqueness information of the multifunction peripheral 10 or the electronic device 12, in response to a request specifying the uniqueness information of the multifunction peripheral 10 or the electronic device 12.

<<Multifunction Peripheral>>

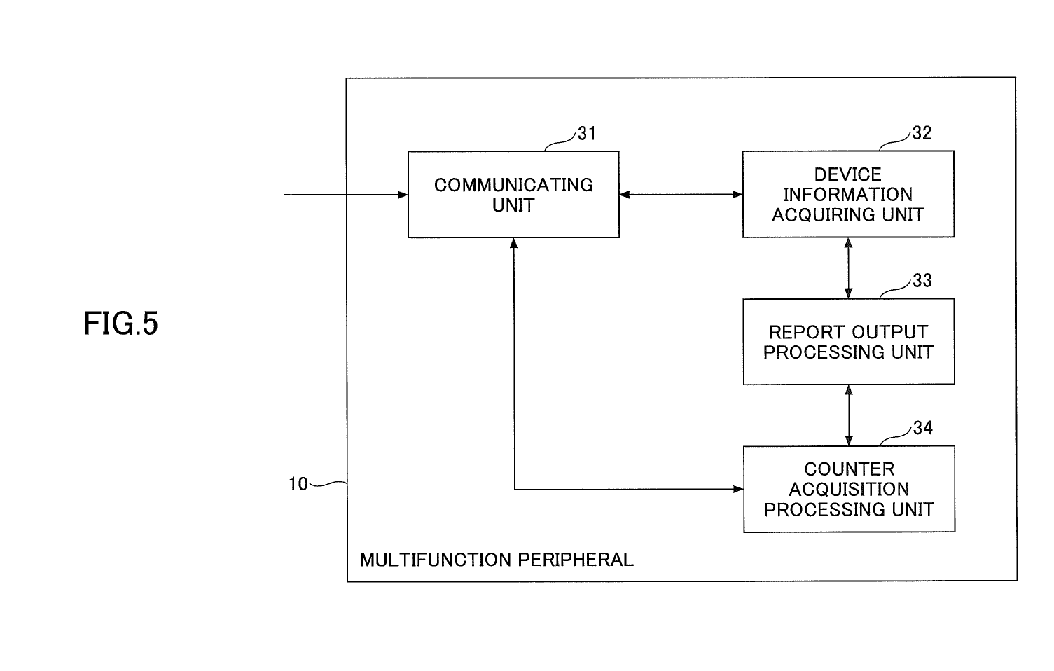

The multifunction peripheral 10 according to the present embodiment is implemented by, for example, the process blocks illustrated in FIG. 5. FIG. 5 is an example of a process block diagram of the multifunction peripheral 10 according to the present embodiment. The multifunction peripheral 10 executes programs to implement the process blocks as illustrated in FIG. 5.

The multifunction peripheral 10 illustrated in FIG. 5 implements a communicating unit 31, a device information acquiring unit 32, a report output processing unit 33, and a counter acquisition processing unit 34. The communicating unit 31 performs data communication with external devices. For example, the communicating unit 31 performs data communication with the electronic device 12, the intermediary device 14, and the counter accumulation device 20.

The device information acquiring unit 32 acquires device information such as a device number (device ID) and a media access control (MAC) address, etc., from the device main body. The device information is an example of uniqueness information of the device (device-uniqueness information). The report output processing unit 33 generates a later-described report from, for example, daily data and monthly data of the multifunction peripheral 10 or the electronic device 12 acquired from the counter accumulation device 20, and displays the report on the operation panel 602. Furthermore, the report output processing unit 33 causes the printer 605 to print out the generated report.

The counter acquisition processing unit 34 acquires, from the counter accumulation device 20, the daily data or the monthly data of the multifunction peripheral 10 or the electronic device 12, requested from the report output processing unit 33, and provides the acquired data to the report output processing unit 33.

<<Settings, Data, and Information>>

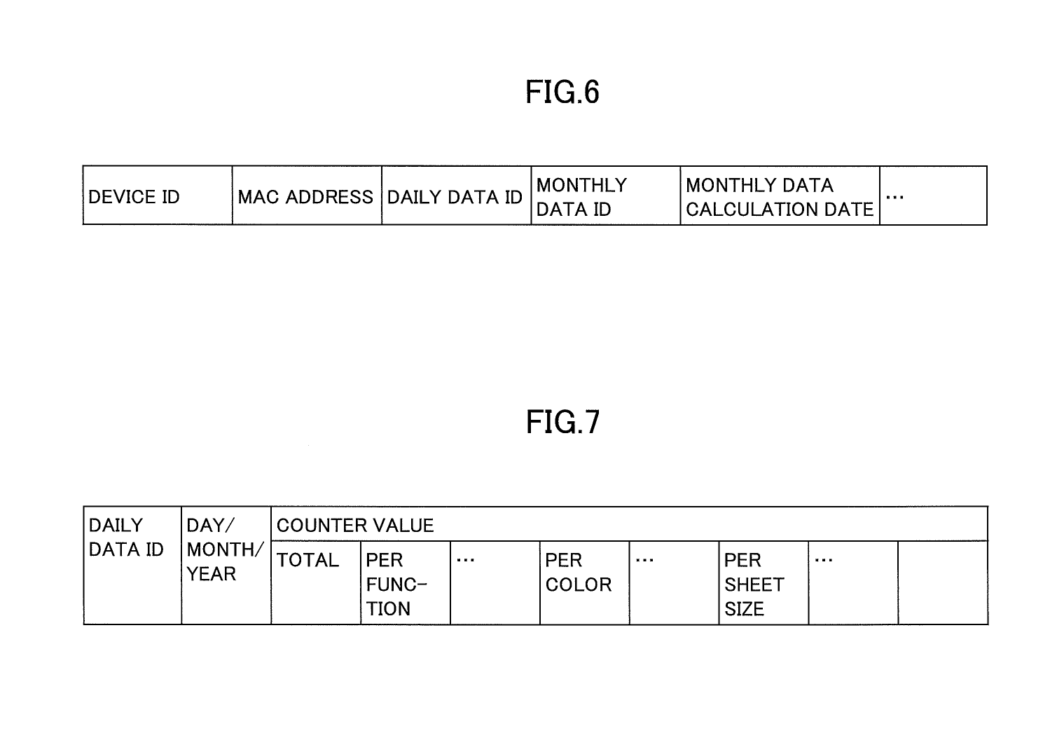

FIG. 6 is a configuration diagram of an example of counter settings. The counter settings include the items of device ID, MAC address, daily data ID, monthly data ID, and monthly data calculation date. The device ID is an example of device information acquired from the main body of the device. The MAC address is an example of device information for uniquely identifying the multifunction peripheral 10 and the electronic device 12 in the communication network. The daily data ID is an example of identification information for uniquely identifying the daily data of the multifunction peripheral 10 or the electronic device 12 identified by the device ID and the MAC address. The monthly data ID is an example of identification information for uniquely identifying the monthly data of the multifunction peripheral 10 or the electronic device 12 electronic device 12 identified by the device ID and the MAC address. The monthly data calculation date indicates the monthly data calculation date for a customer, required for creating the monthly data, etc.

FIG. 7 is a configuration diagram of an example of daily data. The daily data includes the items of daily data ID, day/month/year, and various counter values. The daily data ID is an example of identification information for uniquely identifying the daily data. The day/month/year indicates the date on which the various counter values in the daily data have been counted. The various counter values are daily counter values, including different types of counter values such as total, per function, per color, per sheet size, etc.

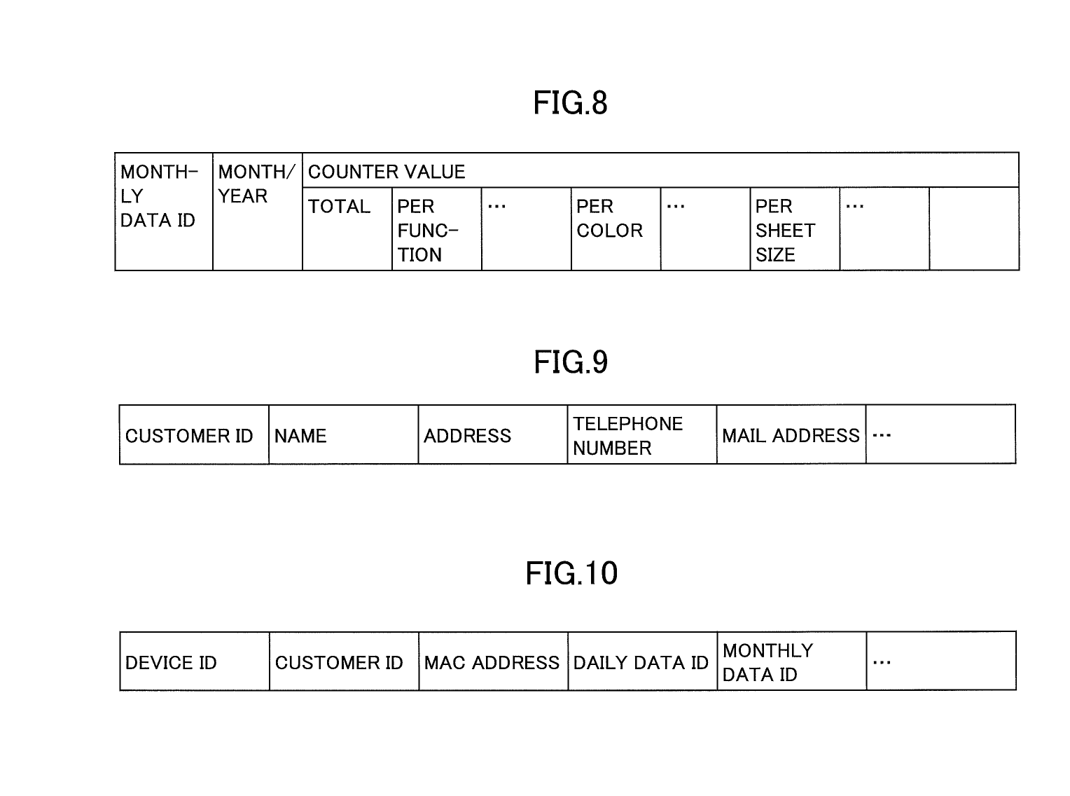

FIG. 8 is a configuration diagram of an example of monthly data. The monthly data includes the items of monthly data ID, month/year, and various counter values. The monthly data ID is an example of identification information for uniquely identifying the monthly data. The month/year indicates the month in which the various counter values in the monthly data have been counted. The various counter values are monthly counter values, including different types of counter values such as total, per function, per color, per sheet size, etc.

FIG. 9 is a configuration diagram of an example of customer information. The customer information includes the items of customer ID, name, address, telephone number, and mail address. The customer ID is an example of identification information for uniquely identifying the customer. The name, address, telephone number, and mail address are the name, the address, the telephone number, and the mail address of the customer. The customer information is used, for example, for displaying the name, the address, the telephone number, and the mail address of the customer, in a report.

FIG. 10 is a configuration diagram of an example of device information. The device information includes the items of device ID, customer ID, MAC address, daily data ID, and monthly data ID. In the device information, the customer ID, the device ID, and the MAC address are associated with each other, and therefore the customer environment and the multifunction peripheral 10 and the electronic device 12 installed in the customer environment are associated with each other.

Furthermore, in the device information, the customer ID, the daily data ID, and the monthly data ID are associated with each other, and therefore the customer and the daily data and the monthly data of the customer are associated with each other. Furthermore, in the device information, the device ID, the MAC address, the daily data ID, and the monthly data ID are associated with each other, and therefore the multifunction peripheral 10 and the electronic device 12, and the daily data and the monthly data of the multifunction peripheral 10 and the electronic device 12, are associated with each other.

### <Processes>

<<Counter Accumulation Process>>

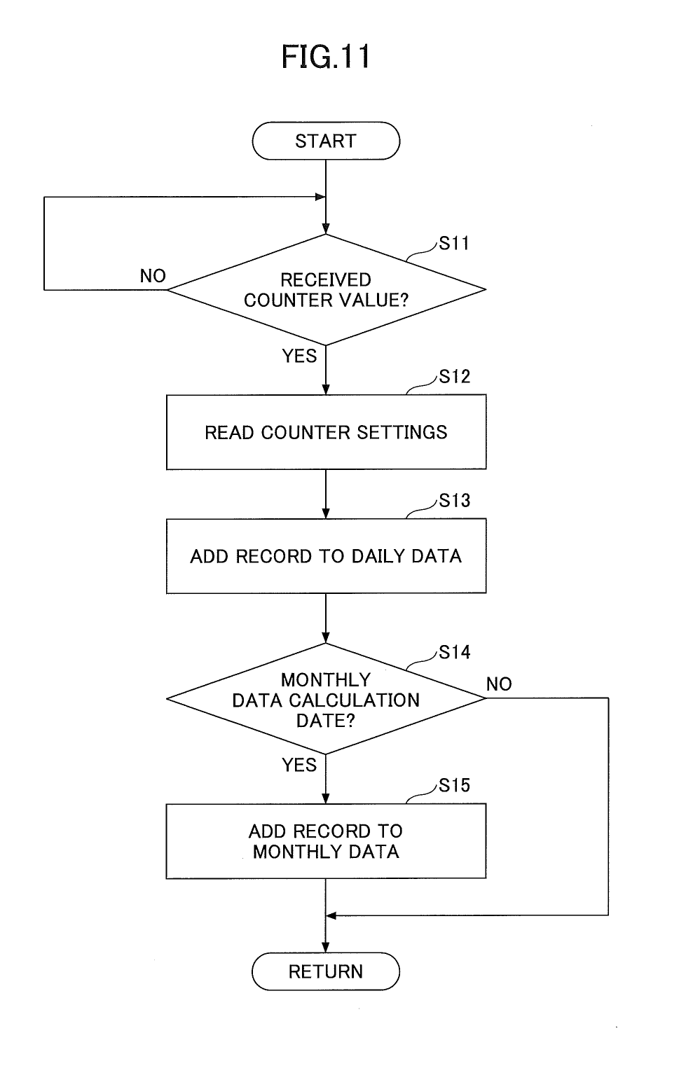

The counter accumulation device 20 of the information processing system 1 according to the present embodiment performs a counter accumulation process by, for example, the procedures illustrated in FIG. 11. FIG. 11 is a flowchart of an example of a counter accumulation process.

The counter accumulation processing unit 24 of the counter accumulation device 20 stands by at step S11, until a counter value is received from the multifunction peripheral 10 or the intermediary device 14 in the customer environment. When the counter accumulation processing unit 24 of the counter accumulation device 20 receives a counter value, the process proceeds to step S12, and the counter accumulation processing unit 24 reads the counter settings of FIG. 6, from the counter setting storage unit 23.

In step S13, the counter accumulation processing unit 24 stores, in the counter storage unit 25, a record of daily data created by attaching a daily data ID to the received counter value, based on the counter settings read in step S12.

In step S14, the counter accumulation processing unit 24 determines whether the monthly data calculation date has elapsed, based on the counter settings read in step S12. When the monthly data calculation date has not elapsed, the counter accumulation processing unit 24 skips the process of step S15 and returns to step S11.

When the monthly data calculation date has elapsed, the process proceeds to step S15, and the counter accumulation processing unit 24 creates the monthly data from the daily data items of one month. Then, the counter accumulation processing unit 24 stores a record of the created monthly data in the counter storage unit 25.

Note that in the example of the flowchart of FIG. 11, after storing the record of the daily data in the counter storage unit 25, when the monthly data calculation date of the customer has elapsed, the monthly data is created based on the daily data; however, the present embodiment is not limited as such. For example, the counter accumulation processing unit 24 may create the monthly data from the daily data at a timing when the monthly data is requested from the multifunction peripheral 10. Furthermore, the counter accumulation processing unit 24 may create weekly data instead of monthly data.

<<Display Process and Print Process of Report>>

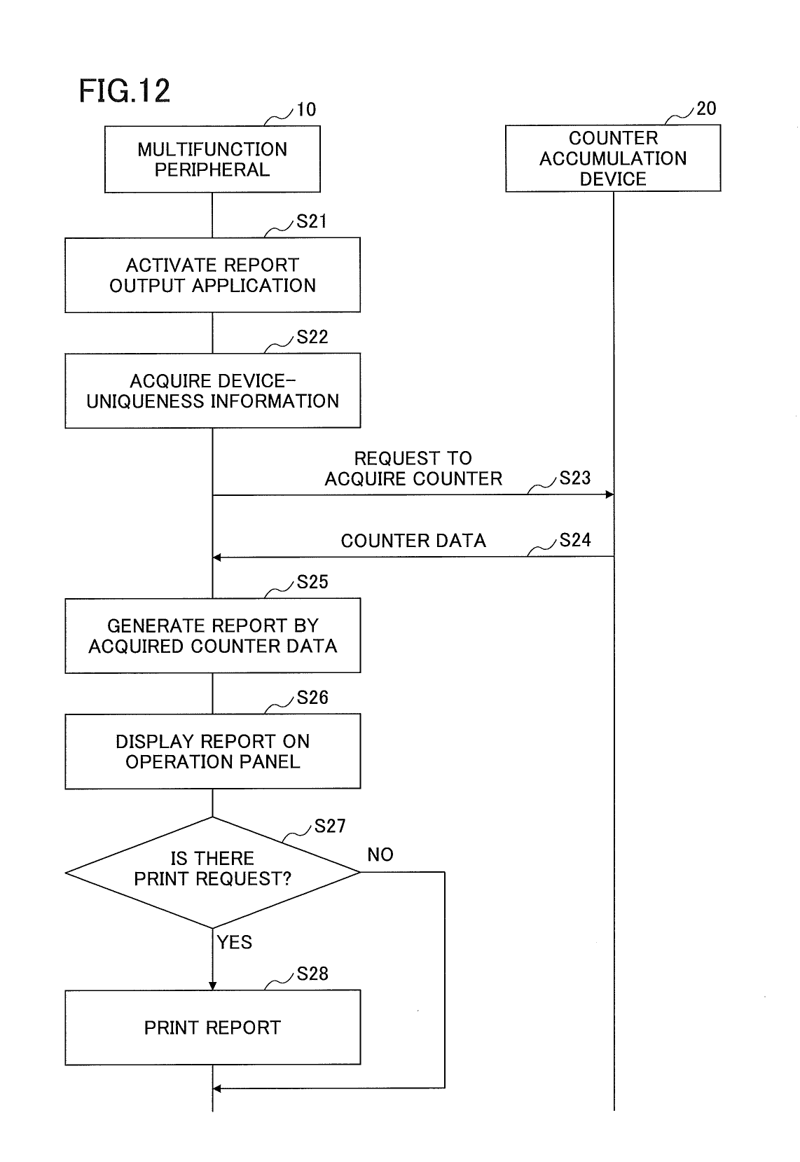

The information processing system 1 according to the present embodiment performs a display process and a print process of a report by, for example, the procedures illustrated in FIG. 12. FIG. 12 is a sequence diagram of an example of a display process and a print process of a report.

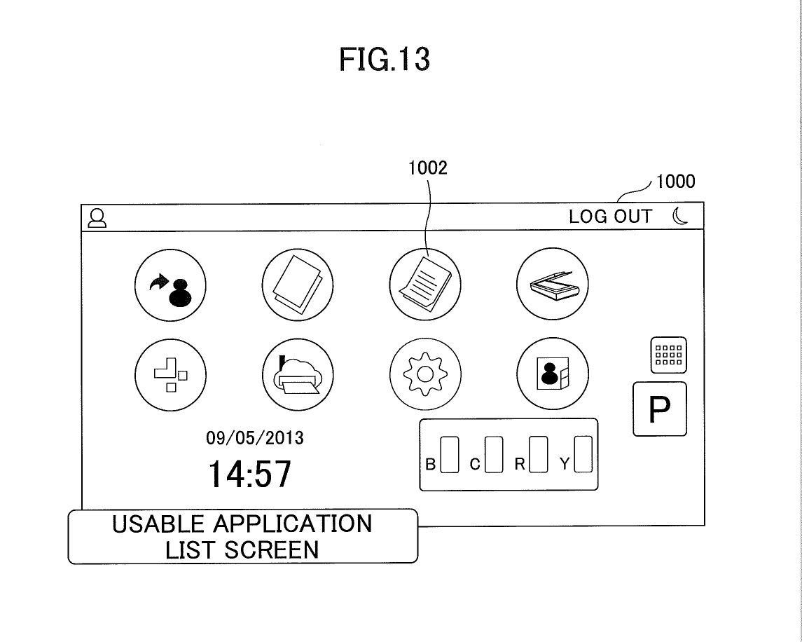

In step S21, for example, a user such as the administrator in the customer environment operates the multifunction peripheral 10 to activate a report output application. The report output application can be activated by having the user select an icon 1002 in the report output application, in a usable application list screen 1000 displayed on the operation panel 602, for example, as illustrated in FIG. 13.

In step S22, the device information acquiring unit 32 of the multifunction peripheral 10 acquires device information such as a device ID and a MAC address, as device-uniqueness information from the main body of the device. In step S23, the counter acquisition processing unit 34 of the multifunction peripheral 10 specifies, in a request, the device information acquired by the device information acquiring unit 32 in step S22, and sends the request to the counter accumulation device 20 to acquire counter data such as daily data and monthly data.

In response to the request to acquire counter data from the multifunction peripheral 10 specifying the device information, the counter provision processing unit 26 of the counter accumulation device 20 reads, from the counter storage unit 25, counter data corresponding to the device information specified in the request. Then, in step S24, the counter provision processing unit 26 returns the counter data corresponding to the device information to the multifunction peripheral 10. For example, the counter provision processing unit 26 may return the counter data of the latest month in step S24.

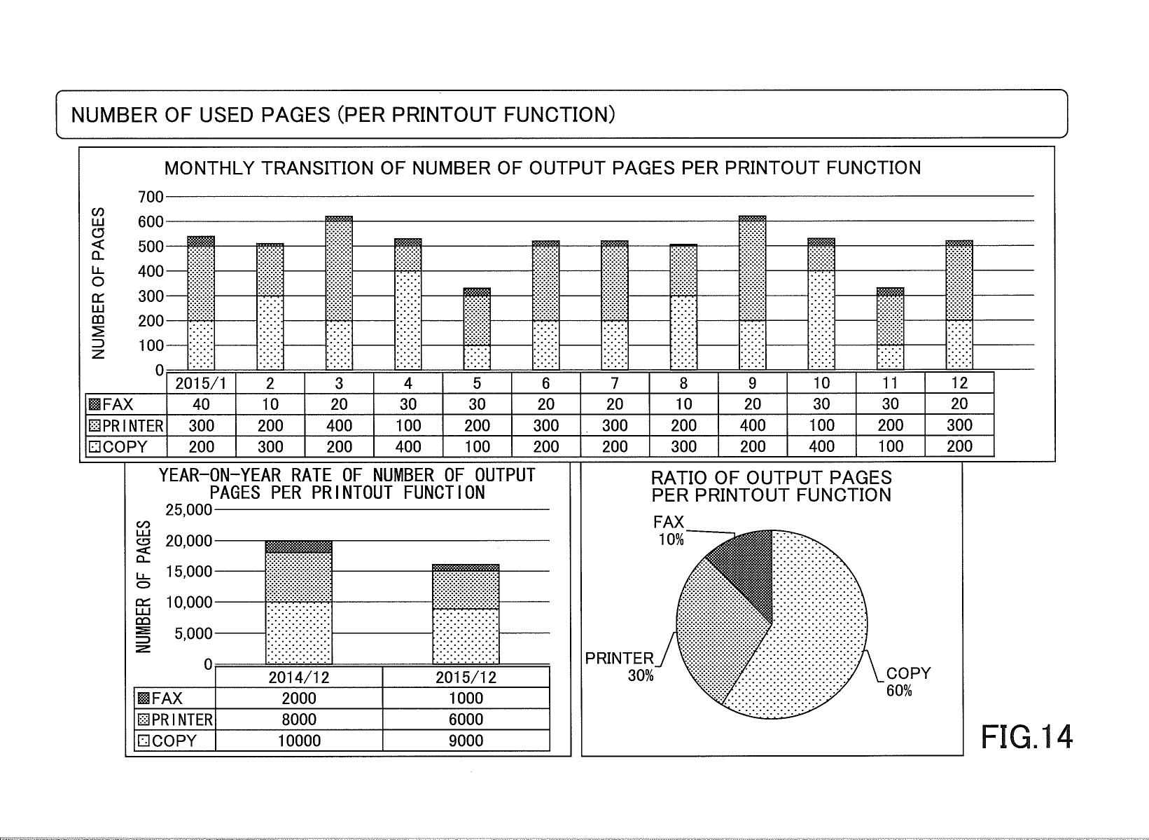

In step S25, the report output processing unit 33 of the multifunction peripheral 10 generates a report based on the counter data returned from the counter accumulation device 20 in step S24. The report may include a graph and a table. In step S26, the report output processing unit 33 displays the report generated in step S25 on the operation panel 602, for example, as illustrated in FIG. 14. FIG. 14 is an image diagram of an example of the report displayed on the operation panel 602.

In step S27, when the report output processing unit 33 accepts a print request for the report from the user, the process proceeds to step S28, and the report output processing unit 33 passes the display data of the report to the printer 605 and causes the printer 605 to print out the report.

Note that in step S23, the counter acquisition processing unit 34 of the multifunction peripheral 10 may specify the device information of another electronic device 12 specified by the user, and request the counter accumulation device 20 to acquire counter data such as daily data and monthly data. In this case, in step S26, the multifunction peripheral 10 does not display its own report, but displays the report of the other electronic device 12.

There are various methods of having the user specify the device information of another electronic device 12; for example, the multifunction peripheral 10 may acquire device-uniqueness information from the electronic device 12 coupled to the network 50, and the user may select the device-uniqueness information.

For example, the multifunction peripheral 10 makes a request for the device-uniqueness information to the electronic device 12, which is coupled to the network 50 by broadcasting or multicasting, and acquires the device-uniqueness information from the electronic device 12. Furthermore, the multifunction peripheral 10 may accept the device-uniqueness information of the electronic device 12 input by a user.

### Other Embodiment

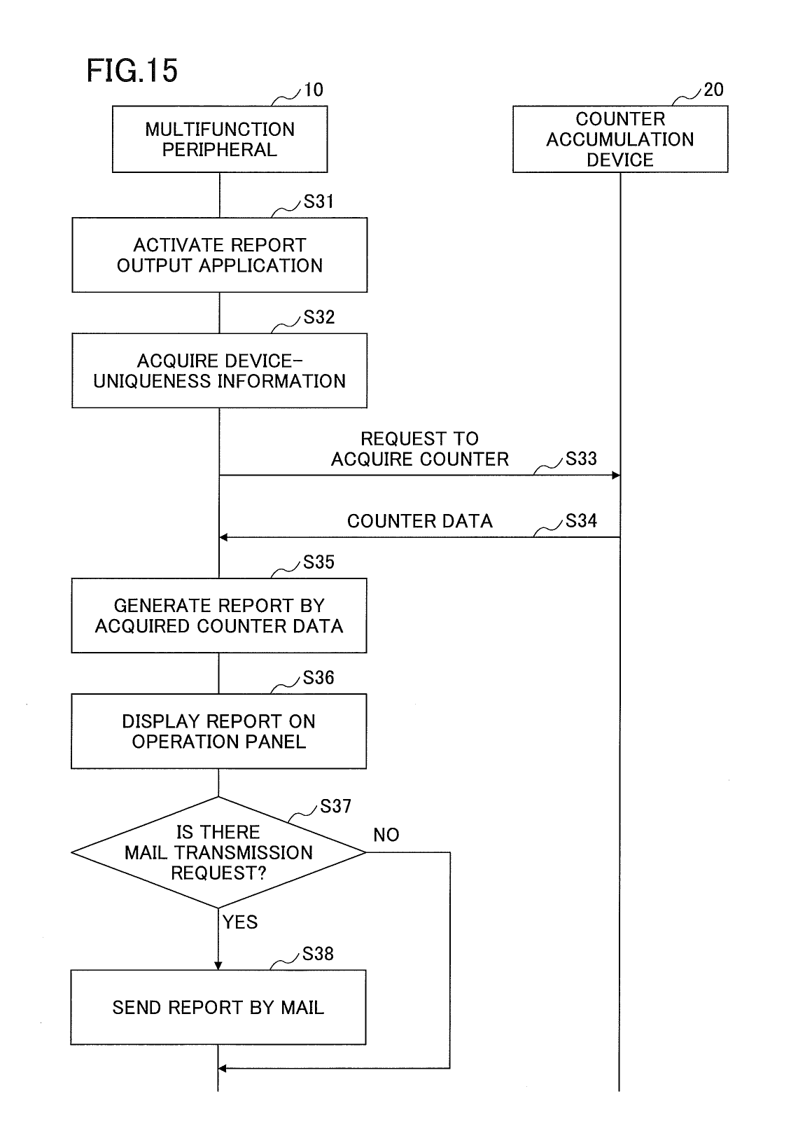

In the first embodiment, in the process illustrated in FIG. 12, the report displayed on the operation panel 602 is printed out. The multifunction peripheral 10 may send the report displayed on the operation panel 602 by mail, as illustrated in FIG. 15.

FIG. 15 is a sequence diagram of an example of a display process and a mail sending process of a report. The processes of steps S31 through S36 are the same as the processes of steps S21 through S26 of FIG. 12.

In step S37, when the report output processing unit 33 accepts a request to send the report by mail from the user, the process proceeds to step S38, and the report output processing unit 33 sends the report by mail. The destination of the mail transmission may be, for example, a mail address in the customer information of FIG. 9 or a mail address input to the operation panel 602.

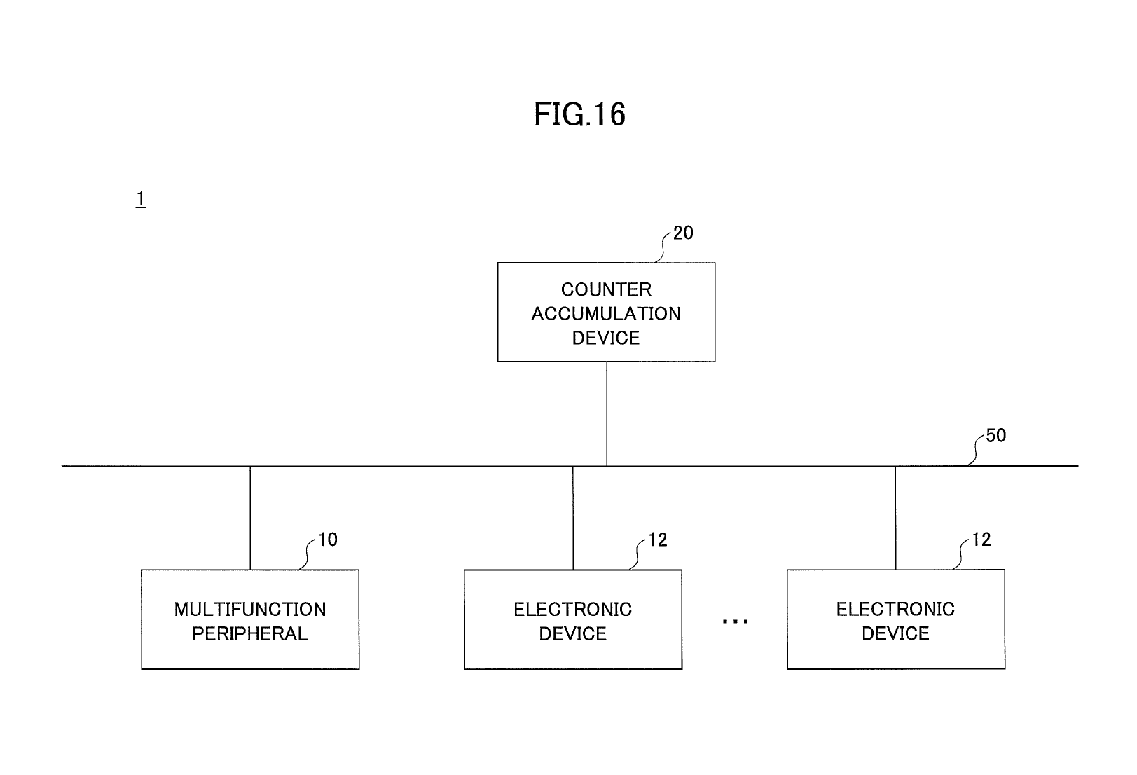

In the information processing system 1 of FIG. 1, the counter accumulation device 20 is coupled to the network 40 such as the Internet outside the customer environment. Said differently, the information processing system 1 of FIG. 1 is an example in which the counter accumulation device 20 is provided in what is termed as a cloud environment. Note that the counter accumulation device 20 may be provided inside the customer environment as illustrated in FIG. 16 (on-premise environment).

FIG. 16 is a configuration of an example of the information processing system 1 according to another embodiment. In the information processing system 1 illustrated in FIG. 16, the multifunction peripheral 10, one or more of the electronic devices 12, and the counter accumulation device 20 are coupled to each other via the network 50 in the customer environment. Note that the hardware configuration, the software configuration and the processes of the information processing system 1 illustrated in FIG. 21 are the same as those of the information processing system 1 illustrated FIG. 1, and therefore descriptions of these contents are omitted.

### (Overview)

As described above, according to the information processing system 1 of the present embodiment, the counter values are not accumulated in the multifunction peripheral 10 or the electronic device 12, but the counter values are accumulated in the counter accumulation device 20, and therefore counter values of a long period of time and multiple types of counter values can be stored, without increasing the recording capacity of the multifunction peripheral 10 or the counter accumulation device 20.

Furthermore, according to the information processing system 1 of the present embodiment, the counter value is stored in association with the device-uniqueness information of the multifunction peripheral 10 and the electronic device 12. The multifunction peripheral 10 can easily acquire the counter value of the multifunction peripheral 10 and the electronic device 12 from the counter accumulation device 20, by sending a request for a counter value specifying the device-uniqueness information of the multifunction peripheral 10 and the electronic device 12, without using another identifier such as a user ID. The multifunction peripheral 10 can create a report of the usage status of the multifunction peripheral 10 and the electronic device 12 from the acquired counter values of the multifunction peripheral 10 and the electronic device 12, and display the report on the operation panel 602 or print out the report. The report of the usage status is based on, for example, per quarterly term, per half-year, per month, per day, accounting, per color, per application, and the environment (kWh and Co₂), etc., of the multifunction peripheral 10 and the electronic device 12.

As described above, according to the information processing system 1 of the present embodiment, the report of the usage status of the multifunction peripheral 10 and the electronic device 12 can be easily displayed on the operation panel 602 of the multifunction peripheral 10, without increasing the recording capacity of the multifunction peripheral 10 or the electronic device 12.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, a personal digital assistant, a mobile telephone (such as a WAP or 3G-compliant phone), and so on. Since the present invention can be implemented as software, each and every aspect of the present invention thus encompasses computer software implementable on a programmable device. The computer software can be provided to the programmable device using any storage medium for storing a processor readable code such as a floppy disk, a hard disk, a CD ROM, a magnetic tape device, or a solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The CPU may be implemented by one or more processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

According to one embodiment of the present invention, it is possible to provide an image forming apparatus that can easily output information relevant to the usage record of the image forming apparatus, without increasing the recording capacity of the image forming apparatus.

The multifunction peripheral 10 is an example of an image forming apparatus. The counter accumulation device 20 is an example of a usage record information storage device.

The device information acquiring unit 32 is an example indicating the function of acquiring device-uniqueness information. The counter acquisition processing unit 34 is an example indicating the function of acquiring device-usage record information. The report output processing unit 33 is an example indicating the function of outputting the device-usage record information. The counter storage unit 25 is an example indicating the function of storing the device-usage record information. The counter provision processing unit 26 is an example indicating the function of providing the device-usage record information.

Furthermore, the device-usage record information is not limited to a counter value. The device-usage record information includes the time of usage, the data amount of captured images, the number of pages of captured images, the communication data amount, the time of outputting data, and the data amount.

The information processing system 1 according to the present embodiment is one example, and there may be various examples of system configurations according to the application and the purpose.

The image forming apparatus, the usage record information output method, and the information processing system are not limited to the specific embodiments described in the detailed description, and variations and modifications may be made without departing from the spirit and scope of the present invention.

What is claimed is:

1. An image forming apparatus for acquiring and displaying device-usage record information, which is related to a usage record of at least one device, the at least one device including the image forming apparatus, the image forming apparatus comprising a processor, in communication with a memory, executing a process including:
acquiring uniqueness information of the image forming apparatus from a usage record information storage device via a network in response to accepting a user operation input via a user interface, the usage record information storage device being configured to receive data from the at least one device, generate the device-usage record information based on the received data, and to store the device-usage record information in association with the uniqueness information of the at least one device;
acquiring, from the usage record information storage device, the device-usage record information stored in association with the acquired uniqueness information of the image forming apparatus; and
outputting the acquired device-usage record information.

2. The image forming apparatus according to claim 1, wherein the outputting includes at least one of displaying the acquired device-usage record information on a display device, printing the acquired device-usage record information by a printing device, and transmitting the acquired device-usage record information by mail.

3. The image forming apparatus according to claim 1, wherein
the acquiring of the uniqueness information includes acquiring the uniqueness information of an electronic device from the electronic device that is coupled via the network, and
the acquiring of the device-usage record information includes acquiring, from the usage record information storage device, the device-usage record information that is stored in association with the acquired uniqueness information of the electronic device.

4. The image forming apparatus according to claim 3, wherein the acquiring of the uniqueness information includes acquiring the uniqueness information of the image forming apparatus or the uniqueness information of the electronic device that is input according to a user operation via an input device.

5. The image forming apparatus according to claim 3, wherein the outputting includes outputting a usage amount of each function of the image forming apparatus or the electronic device, based on a counter value of each function that is increased every time a corresponding function of the image forming apparatus or the electronic device is used, the counter value being acquired as the device-usage record information of the image forming apparatus or the electronic device.

6. The image forming apparatus according to claim 5, wherein the counter value is a lifetime counter value, which is increased every time the corresponding function of the image forming apparatus or the electronic device is used, from when the image forming apparatus or the electronic device is manufactured to a present time point.

7. The image forming apparatus according to claim 5, wherein
the acquiring of the uniqueness information includes acquiring the uniqueness information of the electronic device, which is specified by a user operation input via the user interface,
the acquiring of the device-usage record information includes acquiring, from the usage record information storage device, the counter value that is stored in association with the acquired uniqueness information of the user-specified electronic device, and
the outputting includes outputting the usage amount of the user-specified electronic device.

8. A method for outputting device-usage record information executed by a computer in communication with a memory, the method being implemented in an image forming apparatus for acquiring and displaying the device-usage record information, which is related to a usage record of at least one device, the at least one device including the image forming apparatus, the method comprising:
acquiring uniqueness information of the image forming apparatus from a usage record information storage device via a network in response to accepting a user operation input via a user interface, the usage record information storage device being configured to receive data from the at least one device, generate the device-usage record information based on the received data, and to store the device-usage record information in association with the uniqueness information of the at least one device;
acquiring, from the usage record information storage device, the device-usage record information stored in association with the acquired uniqueness information of the image forming apparatus; and
outputting the acquired device-usage record information.

9. The method according to claim 8, wherein the outputting includes at least one of displaying the acquired device-usage record information on a display device, printing the acquired device-usage record information by a printing device, and transmitting the acquired device-usage record information by mail.

10. The method according to claim 8, wherein
the acquiring of the uniqueness information includes acquiring the uniqueness information of an electronic device from the electronic device that is coupled via the network, and
the acquiring of the device-usage record information includes acquiring, from the usage record information storage device, the device-usage record information that is stored in association with the acquired uniqueness information of the electronic device.

11. The method according to claim 10, wherein the acquiring of the uniqueness information includes acquiring the uniqueness information of the image forming apparatus or the uniqueness information of the electronic device that is input according to a user operation via an input device.

12. The method according to claim 10, wherein the outputting includes outputting a usage amount of each function of the image forming apparatus or the electronic device, based on a counter value of each function that is increased every time a corresponding function of the image forming apparatus or the electronic device is used, the counter value being acquired as the device-usage record information of the image forming apparatus or the electronic device.

13. The method according to claim 12, wherein the counter value is a lifetime counter value, which is increased every time the corresponding function of the image forming apparatus or the electronic device is used, from when the image forming apparatus or the electronic device is manufactured to a present time point.

14. The method according to claim 12, wherein
the acquiring of the uniqueness information includes acquiring the uniqueness information of the electronic device, which is specified by a user operation input via the user interface,
the acquiring of the device-usage record information includes acquiring, from the usage record information storage device, the counter value that is stored in association with the acquired uniqueness information of the user-specified electronic device, and
the outputting includes outputting the usage amount of the user-specified electronic device.

15. An information processing system including one or more information processing apparatuses coupled via a network for implementing functions of the information processing system, the information processing system including an image forming apparatus for acquiring and displaying device-usage record information, which is related to a usage record of at least one device, the at least one device including the image forming apparatus, the information processing system comprising one or more processors, in communication with a memory, executing a process including:
storing the device-usage record information in association with uniqueness information of the at least one device in at least one of the information processing apparatuses, the device-usage record information being generated based on data received from the at least one device;
accepting, from the image forming apparatus according to a user operation input via a user interface, an acquisition request specifying the uniqueness information, requesting to acquire the device-usage record information, and providing, to the image forming apparatus, the device-usage record information associated with the uniqueness information specified in the acquisition request;
acquiring the uniqueness information of the image forming apparatus;
requesting the at least one of the information processing apparatuses to provide the device-usage record information stored in association with the acquired uniqueness information of the image forming apparatus, and acquiring the device-usage record information from the at least one of the information processing apparatuses; and
outputting the acquired device-usage record information.
